(19) United States
(12) Patent Application Publication
(10) Pub. No.: US 2014/0223286 A1
(43) Pub. Date: Aug. 7, 2014

(54) Method of Displaying Multimedia Contents

(71) Applicant: InfoPower Corporation, Taipei (TW)

(72) Inventors: Jer-Bin Lin, New Taipei City (TW); Che-Yu Lee, New Taipei City (TW); Chun-Lin Chen, Tainan City (TW)

(73) Assignee: InfoPower Corporation, Taipei (TW)

(21) Appl. No.: 14/173,781

(22) Filed: Feb. 5, 2014

Related U.S. Application Data
(60) Provisional application No. 61/762,292, filed on Feb. 7, 2013.
(60) Provisional application No. 61/807,777, filed on Apr. 3, 2013.

(51) Int. Cl. G06F 3/0488; G06F 17/22; G06F 3/0486

(52) U.S. Cl. CPC G06F 3/0488; G06F 3/0486; G06F 17/2247
USPC 715/234

(57) ABSTRACT

While a cursor of a URL object dragging command including a URL object is dragged to a preview spot displayed on a user interface of a touch panel, only multimedia contents of a website indicated by a URL address forming the URL object are displayed on the user interface for preview. Advertisements, comments, extra images of the webpage are filtered out under the preview procedure.

### CROSS REFERENCE TO RELATED APPLICATIONS

This non-provisional application claims priority of U.S. provisional application 61/762,292 filed on Feb. 7, 2013 and U.S. provisional application 61/807,777 filed on Apr. 3, 2013.

### BACKGROUND OF THE INVENTION

1. Field of the Invention

The present invention relates to a method of displaying multimedia contents, and more particularly, a method of displaying multimedia contents on a touch panel.

2. Description of the Prior Art

In a conventional browser installed on a touch panel, there is a web address bar for inputting a web address, i.e., a universal resource locator (URL), so that the browser is capable of browsing a website indicated by the web address un response. While the browser is configured to browse the website, all elements including multimedia contents, text contents, and even applications are required to be downloaded to the browser for processing and displaying, or a user of the touch panel cannot confirm contents of the webpage on the touch panel. If the webpage is not wanted nor interesting for the user, downloading all contents of the webpage for browsing is time-wasting for the user, and it may get worse when the downloaded applications are configured to display unwanted advertisements for the user on the touch panel.

### SUMMARY OF THE INVENTION

The claimed invention discloses a method of displaying multimedia contents. The method comprises: receiving a universal resource locator (URL) object dragging command configured to drag a URL object on a touch panel; and displaying audio/video (A/V) contents of a webpage indicated by the URL object on the touch panel when a cursor of the URL object dragging command is dragged to a preview spot on the touch panel by the URL object dragging command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 illustrate how the method of displaying multimedia contents works according to some embodiments of the present invention.

FIG. 4 illustrates the method of displaying multimedia contents of the present invention according to the embodiments shown in FIGS. 1-3.

### DETAILED DESCRIPTION

For relieving a user of a touch panel from wasting time on browsing an unwanted webpage, the present invention discloses a method of displaying multimedia contents for preview the webpage. Note that the touch panel maybe a smart pad or a smart phone in some embodiments of the present invention.

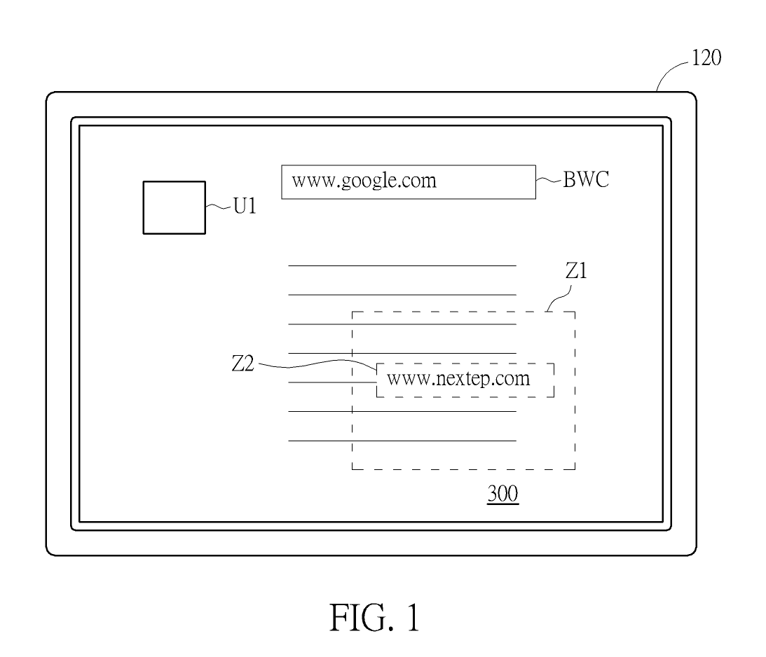

Please refer to FIGS. 1-3, which illustrate how the method of displaying multimedia contents works according to some embodiments of the present invention. As shown in FIG. 1, a touch panel 120 is configured to install a browser program and to display a user interface 300 for the browser program so that a user of the touch panel 120 is able to manipulate the browser program via the user interface 300.

As shown in the user interface 300, a browser icon UI is configured to initiate the browser program (or a browser function of a multi-function program) in response to a touch command triggered on the browser icon UI. Note that there may also be other icons for implementing other functions of the user interface 300 in embodiments of the present invention, and the other icons are not illustrated for focusing on the browser program.

Note that the following introduced operations are supported by the browser program, that is, any operation run on the user interface 300 while the browser icon UI is triggered is supported by the browser program.

While the browser icon UI is triggered, a web address bar BWC is further displayed by the user interface 300. Assume the user inputs a first address “www.google.com” into the web address bar, the user interface 300 is configured to display a first webpage indicated by the first address.

In one embodiment of the present invention, the user may further input a section cutting touch command on the user interface 300 for cutting a sectional object Z1 from the first webpage. The user interface 300 is configured to identify any text image included by the sectional object Z1 for identifying a URL, for example, a second address “www.nextep.com” shown in FIG. 1. Then the user interface 300 is configured to generate a URL object Z2 for indicating the second address “www.nextep.com”.

In one embodiment of the present invention, the user interface 300 is configured to automatically identify at least one web address within the first webpage and generate at least one URL object respectively corresponding to the at least one web address, for example, the URL object Z2.

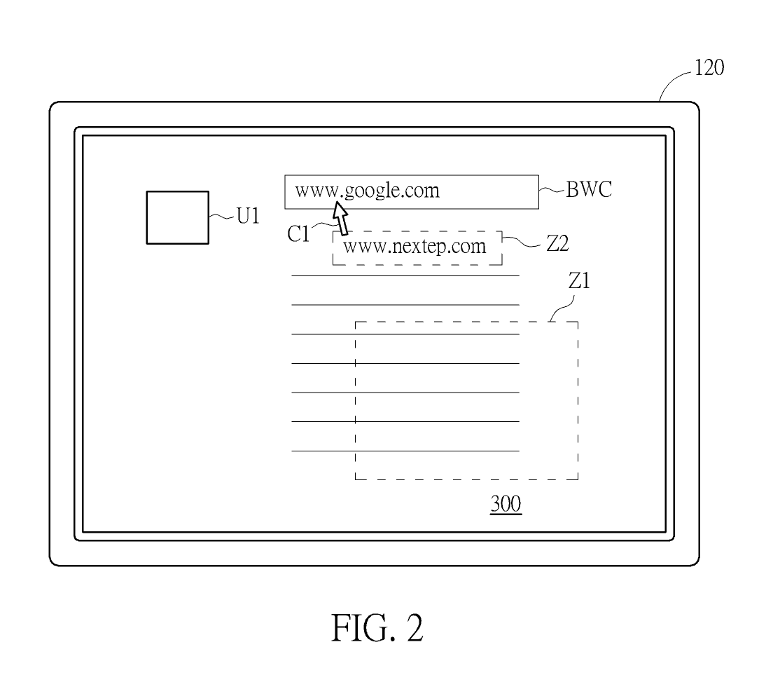

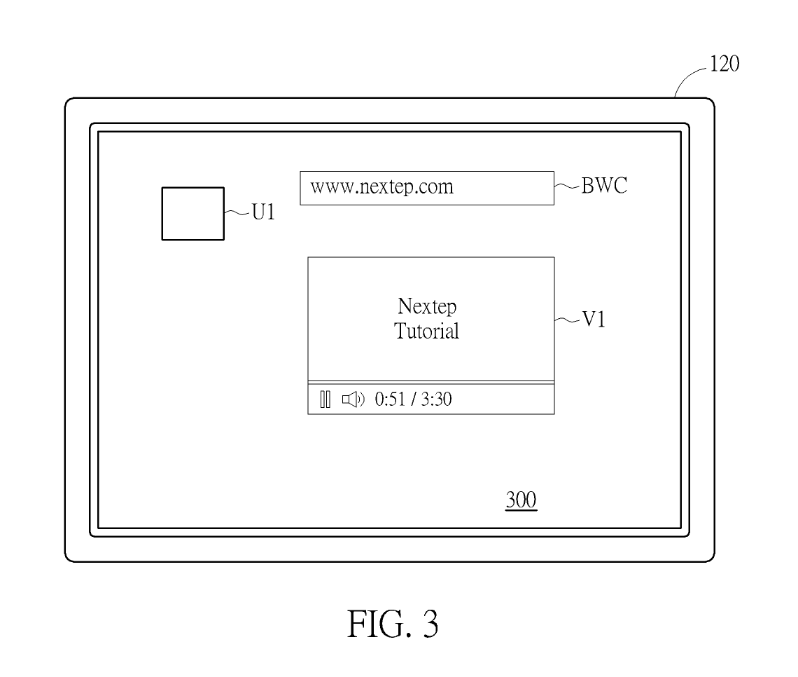

In FIG. 2, a URL object dragging command is inputted by the user of the touch panel 120 for dragging the URL object Z2 on the user interface 300 of the touch panel 120. While a cursor C1 of the URL dragging command is dragged to the web address bar BWC as a preview spot with or without releasing the URL object dragging command, as shown in FIG. 3, the user interface 300 is configured to automatically download and display only multimedia contents of the second address “www.nextep.com”, such as a multimedia content V1 indicating a video clip of the second address, for completing a preview procedure of the user interface 300. Note that the multimedia contents may also be regarded as audio/video (A/V) contents. Advertisements, comments, extra images of the webpage are filtered out under the preview procedure.

Note that the URL object Z2 may be or may not be located on the cursor C1, however, the URL object Z2 is dragged simultaneously and synchronically with the cursor C1 while the URL object dragging command is utilized on the user interface 300.

In one embodiment of the present invention, a mail icon is further displayed by the user interface, so that when the cursor C1 is dragged to the mail icon with or without releasing the URL dragging command, the user interface 300 is configured to mail the URL indicated by the URL object Z2 to a predetermined mail address.

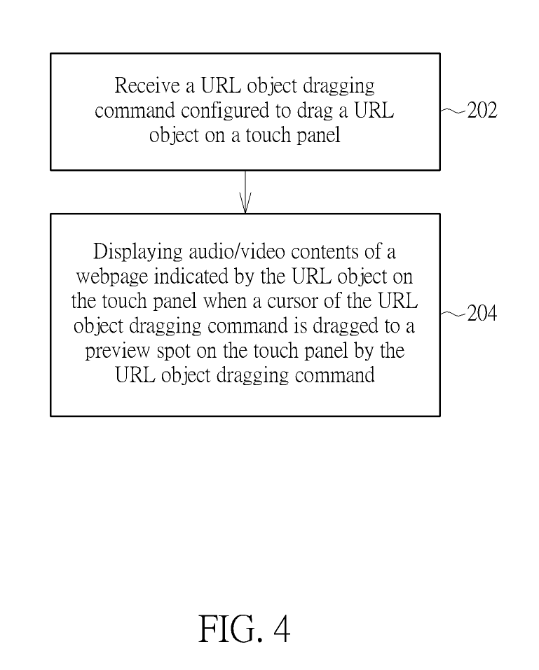

Please refer to FIG. 4, which illustrates the method of displaying multimedia contents of the present invention according to the embodiments shown in FIGS. 1-3.

Step 202: Receive a URL object dragging command configured to drag the URL object Z2 on the touch panel 120.

Step 204: Displaying audio/video (A/V) contents of a webpage indicated by the URL object dragging command on the touch panel 120 when the URL object Z2 is dragged to a preview spot on the touch panel 120 by the URL object dragging command.

Embodiments formed by reasonable combination/permutation or by adding any limitation mentioned in this specification should also be regarded as embodiments of the present invention.

With the aid of the method of displaying multimedia contents of the present invention, a user of a touch panel utilizing a browser program supported by the method of displaying multimedia contents of the present invention can be relieved from wasting time on downloading all contents of a unwanted webpage, instead, the user is able to confirm multimedia contents of a to-be-browsed webpage in advance for preview.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of displaying multimedia contents, comprising:
receiving a universal resource locator (URL) object dragging command configured to drag a URL object on a touch panel ; and
displaying audio/video (A/V) contents of a webpage indicated by the URL object on the touch panel when a cursor of the URL object dragging command is dragged to a preview spot on the touch panel by the URL object dragging command.

2. The method of claim 1, further comprising:
filtering out advertisements, comments, extra images of the webpage.

3. The method of claim 1, further comprising:
cutting a sectional object on the touch panel in response to a section cutting command;
identifying text images on the sectional object to identify a URL on the sectional object; and
generating the URL object according to the URL.

4. The method of claim 3, further comprising:
sharing the URL object by emailing the sectional object to a remote electronic device via a content mailing command on the touch panel.

5. The method of claim 1, wherein the touch panel is a smart pad or a smart phone.
